(19) United States
(12) Patent Application Publication
(10) Pub. No.: US 2016/0255336 A1
(43) Pub. Date: Sep. 1, 2016

(54) 3D Intelligent Device and 3D Image Display Method therefor

(71) Applicant: AIKE TECHNOLOGY CO., LTD., Chaoyang District, Beijing (CN)

(72) Inventor: HONGLIANG WANG, BEIJING (CN)

(73) Assignee: AIKE TECHNOLOGY CO., LTD, Beijing (CN)

(21) Appl. No.: 15/033,326

(22) PCT Filed: Jul. 29, 2014
(86) PCT No.: PCT/CN2014/083197

§ 371 Date: Apr. 29, 2016

(30) Foreign Application Priority Data
Nov. 1, 2013 (CN) 201310529684.X

(51) Int. Cl. H04N 13/04; G02B 27/01

(52) U.S. Cl. CPC H04N 13/044; G02B 27/017; H04N 13/0436; G02B 2027/0138; G02B 2027/0178

(57) ABSTRACT

A 3D intelligent device and a method for collecting, transmitting and displaying a 3D image based on same. The device comprises a spectacle frame, lenses, a collection device which is used for synchronously collecting two-dimensional images from left and right viewing angles respectively through two cameras located at left and right lenses, and merging the collected two-dimensional images into a three-dimensional image; a background light detection device used for detecting background brightness in front of eyes; a display device used for parsing the three-dimensional image into two-dimensional images of left and right eyes; and a mode control device used for detecting that the user is in a moving state or a stationary state, and switching the 3D intelligent device to a corresponding moving mode or direct vision mode according to a detection result. Therefore, a user can conveniently collect, transmit and display a 3D image.

### FIELD OF THE INVENTION

The present invention relates to the field of intelligent, wearable devices, and particularly to a three-dimensional (3D) intelligent device and its 3D image display method.

### BACKGROUND OF THE RELATED ARTS

At the current era with rapid development of the mobile Internet, intelligent, wearable devices, such as intelligent spectacles, appear to satisfy the increasing need of the people. However, as for currently available spectacle displays, since the display assemblies are simply disposed at the front portion of the spectacles, the front sight of the eyes is occluded. At the same time, in the case of conventional spectacle displays, the spectacles are simply additionally equipped with light-shielding hoods for clear display, but the human sight is almost totally shielded to such an extent that the spectacle displays are not suitable for moving occasions. Moreover, in the case of certain moving smart spectacles, in order to avoid shielding of the sight, the screens are disposed at front and upper portions relative to the eyeballs, which have to be raised for browsing, and this causes fatigue in long-time viewing in video applications and the like.

The displays of traditional intelligent spectacles cannot achieve 3D effects due to the limitation of single-eye display, and, with the transparent design, the user cannot clearly see the screen under highlight background. The displays of traditional spectacles can only capture and share 2D images, while there are few means for capturing, processing, propagating and experiencing 3D images; at the same time, traditional 3D image collection devices are usually relatively unwieldy, and the 3D images, propagating and experiencing devices are usually independent of one another, and low in efficiency, so the user usually finds it impossible to immediately experience after 3D images collection, and cannot effectively evaluate the quality of the collected 3D images, thus experiencing inconvenience in the process.

In the case of the displays of traditional spectacles, since the brightness of the display screen cannot be automatically adjusted, the user can only passively adapt to the circumstance when the background brightness is changed—for example, when the background becomes brighter while the display is still in the darker state, it is then necessary for the eyes of the user to be repetitively adjusted to adapt to the bright background and the dark screen, whereby it is easy to cause eye fatigue, thus causing myopia. Moreover, when the background becomes bright, the screen brightness cannot be automatically lowered, thus in turn causing great power consumption of the screen, to the detriment of power saving and prolongation of standby time.

In summary, conventional intelligent spectacles are problematic in ways listed below: 1) incapability to achieve 3D effects due to limitation of single-eye display; and 2) mere capturing and sharing of 2D images, while lacking means for capturing, processing, transmitting and displaying 3D images.

### SUMMARY OF THE INVENTION

It is the objective of the present invention to provide a 3D intelligent device and its 3D image display method. The device comprises a spectacle frame and lenses, and further comprises a collection device, for synchronously collecting two-dimensional images through two cameras disposed at the left and right lenses from left and right viewing angles, respectively, and merging the collected two-dimensional images into a three-dimensional image; a background light detection device, for detecting background brightness in front of eyes; a display device, for parsing the three-dimensional image into two-dimensional images of left and right eyes, presenting the same to a user, and for adjusting display brightness according to the background brightness; and a mode control device, for detecting whether the user is in a moving state or a stationary state, and switching the 3D intelligent device to a corresponding moving mode or direct vision mode according to a detection result, whereby the aforementioned problems are solved, so that users can conveniently collect, transmit and display 3D images.

According to one aspect of the present invention, there is provided a 3D intelligent device, which comprises a spectacle frame and lenses, and further comprises a collection device, for synchronously collecting two-dimensional images through two cameras disposed at the left and right lenses from left and right viewing angles, respectively, and merging the collected two-dimensional images into a three-dimensional image; a background light detection device, for detecting background brightness in front of eyes; a display device, for parsing the three-dimensional image into two-dimensional images of left and right eyes, presenting the same to a user, and for adjusting display brightness according to the background brightness; and a mode control device, for detecting whether the user is in a moving state or a stationary state, and switching the 3D intelligent device to a corresponding moving mode or direct vision mode according to a detection result.

The display device comprises minitype, light-weight, high-resolution displays, which are disposed, respectively, on outer sides of the left and right lenses, whose positions are adjustable leftwards and rightwards according to pupil distance; minitype, left-eye and right-eye two-dimensional images of the displays enter an optical amplification module to be amplified there into virtual, large-size, left-eye and right-eye two-dimensional images for entry into human eyes after having been reflected once or twice by means of a total reflection module made of a transparent material, wherein the reflection module and the optical amplification module have an included angle of 45° therebetween.

The background light detection device is disposed on the outer side of the lens, and the display device is capable of automatically or manually adjusting display brightness in accordance with the background brightness; when the lens is a photochromatic lens whose color is automatically changeable in accordance with the background brightness, a same photochromatic lens is also added before the background light detection device, so that luminous intensity detected by the background light detection device is consistent with luminous intensity behind the lens formed by the photochromatic lens; alternatively, relationship between background luminous intensity and light transmittance of the photochromatic lens is detected beforehand, and, in the case the photochromatic lens is used as the lens, the background luminous intensity is first obtained through the background light detection device, light transmittance of the photochromatic lens is tested under the background luminous intensity, and screen brightness of the display is set via simulation calculation through software in accordance with the light transmittance of the photochromatic lens.

The lens is one of a myopic mirror, a hyperopic mirror, and a clear mirror, and the lens is freely substitutable among the myopic mirror, the hyperopic mirror, and the clear mirror; position of a nose pad of the spectacle frame is adjustable upwards and downwards in accordance with control of the mode control device to achieve switch between the moving mode and the direct vision mode.

The device further comprises a transmission device, which includes at least one of a wired transmission module and a wireless transmission module, for receiving three-dimensional images from the collection device or other external devices, or transmitting three-dimensional images to other external devices; and a storage device, for storing three-dimensional images from the collection device or other external devices.

According to another aspect of the present invention, there is provided a 3D image display method based on the 3D intelligent device, which method comprises the steps of synchronously collecting two-dimensional images from left and right viewing angles, respectively, through two cameras disposed at left and right lenses; merging the collected two-dimensional images into a three-dimensional image; parsing the three-dimensional image into two-dimensional images of left and right eyes; amplifying and displaying the two-dimensional images of left and right eyes through a display device; wherein the displaying comprises adjusting display brightness according to background brightness in front of eyes detected by a background light detection device; detecting whether a user is in a moving state or a stationary state, and switching display effect to a corresponding moving mode or direct vision mode according to a detection result.

The step of amplifying and displaying the two-dimensional images of left and right eyes through a display device comprises: displaying two-dimensional minitype images of left and right eyes through minitype, light-weight, high-resolution displays, which are disposed, respectively, on outer sides of left and right lenses, whose positions are adjustable leftwards and rightwards according to pupil distance; entering the two-dimensional images into an optical amplification module to be amplified there into virtual, large-size, left-eye and right-eye two-dimensional images for entry into human eyes after having been reflected once or twice by means of a total reflection module made of a transparent material; wherein the reflection module and the optical amplification module have an included angle of 45° therebetween.

The background light detection device is disposed on the outer side of the lens, and the display device is capable of automatically or manually adjusting display brightness in accordance with the background brightness; when the lens is a photochromatic lens whose color is automatically changeable in accordance with the background brightness, a same photochromatic lens is also added before the background light detection device, so that luminous intensity detected by the background light detection device is consistent with luminous intensity behind the lens formed by the photochromatic lens; alternatively, relationship between background luminous intensity and light transmittance of the photochromatic lens is detected beforehand, and, in the case the photochromatic lens is used as the lens, the background luminous intensity is first obtained through the background light detection device, light transmittance of the photochromatic lens is tested under the background luminous intensity, and screen brightness of the display is set via simulation calculation through software in accordance with the light transmittance of the photochromatic lens.

The 3D intelligent device comprises a spectacle frame; the lens is one of a myopic mirror, a hyperopic mirror, and a clear mirror, and that the lens is freely substitutable among the myopic mirror, the hyperopic mirror, and the clear mirror; wherein position of a nose pad of the spectacle frame is adjustable upwards and downwards in accordance with the detected state and mode of the user to achieve switch between the moving mode and the direct vision mode.

The method further comprises the steps of receiving, through a transmission device that includes at least one of a wired transmission module and a wireless transmission module, three-dimensional images from other external devices or a collection device that includes the two cameras; and storing, through a storage device, the three-dimensional images from the other external devices or the collection device.

The present invention provides a 3D intelligent device and its 3D image display method. The device comprises a spectacle frame and lenses, and further comprises a collection device, for synchronously collecting two-dimensional images through two cameras disposed at the left and right lenses from left and right viewing angles, respectively, and merging the collected two-dimensional images into a three-dimensional image; a background light detection device, for detecting background brightness in front of eyes; a display device, for parsing the three-dimensional image into two-dimensional images of left and right eyes, presenting the same to a user, and for adjusting display brightness according to the background brightness; and a mode control device, for detecting whether the user is in a moving state or a stationary state, and switching the 3D intelligent device to a corresponding moving mode or direct vision mode according to a detection result, whereby the aforementioned problems are solved, so that users can conveniently collect, transmit and display 3D images. Further, the present invention provides display effects of a large screen, and achieves light-weight and convenient carriage of the device; moreover, by virtue of pupil distance adjusting mechanism and transmission device, personalized need of users and need for the mobile Internet can be better satisfied.

### BRIEF EXPLANATIONS OF THE ACCOMPANYING DRAWINGS

FIG. 1 is a schematic diagram illustrating the structure of a 3D intelligent device according to the present invention;

FIG. 2 is a schematic diagram illustrating the structure of a display device in the 3D intelligent device according to the present invention;

FIG. 3 is another schematic diagram illustrating the structure of a display device in the 3D intelligent device according to the present invention;

FIG. 4 is a schematic diagram illustrating the translation structure of a display device in the 3D intelligent device according to the present invention;

FIG. 5 is a schematic diagram illustrating the structure of a nose pad in the 3D intelligent device according to the present invention;

FIG. 6 is another schematic diagram illustrating the structure of a nose pad in the 3D intelligent device according to the present invention; and

FIG. 7 is a processing flowchart illustrating a method based on collecting, transmitting and displaying a 3D image by means of a 3D intelligent device according to the present invention.

### SPECIFIC EMBODIMENTS FOR CARRYING OUT THE INVENTION

To make the objectives, technical solutions and advantages of the present invention more clear and apparent, specific embodiments are incorporated below with reference to the accompanying drawings to further describe the present invention in details. As should be understood, the description below is merely exemplary in nature, rather than restrictive of the scope of the present invention. In addition, structures and technologies known to the public are omitted in the description below to avoid unnecessary confusion of concepts of the present invention.

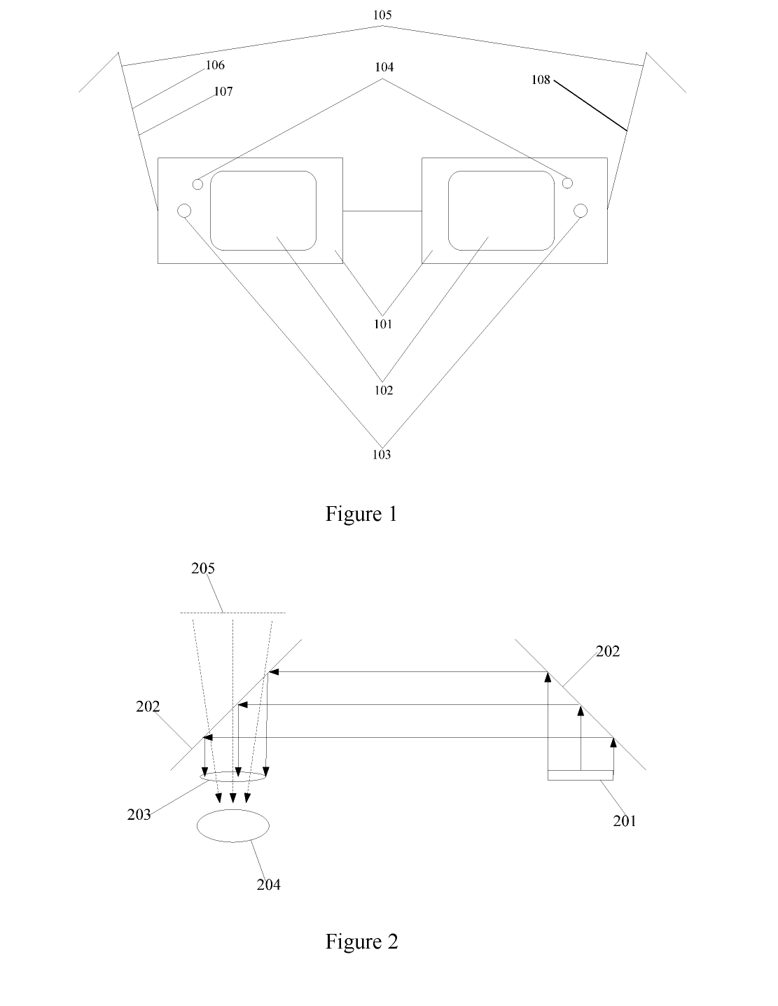

FIG. 1 is a schematic diagram illustrating the structure of a 3D intelligent device according to the present invention, which device comprises:

lenses 101;

display devices 102 disposed on the lenses 101, for parsing the three-dimensional image into two-dimensional images of left and right eyes, presenting the same to a user, and for adjusting display brightness according to the background brightness;

collection devices 103 disposed on the lenses 101, for synchronously collecting two-dimensional images through two cameras disposed at the left and right lenses from left and right viewing angles, respectively, and merging the collected two-dimensional images into a three-dimensional image;

background light detection devices 104 disposed on the lenses 101, for detecting background brightness in front of eyes;

a mode control device 108, for detecting whether the user is in a moving state or a stationary state, and switching the 3D intelligent device to a corresponding moving mode or direct vision mode according to a detection result; and

a spectacle frame 105.

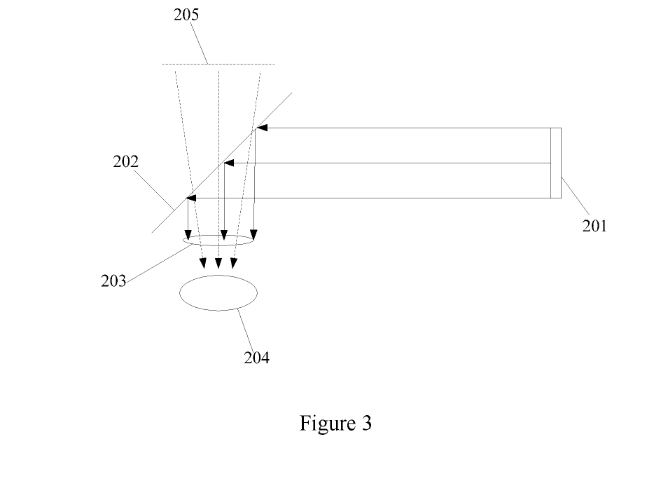

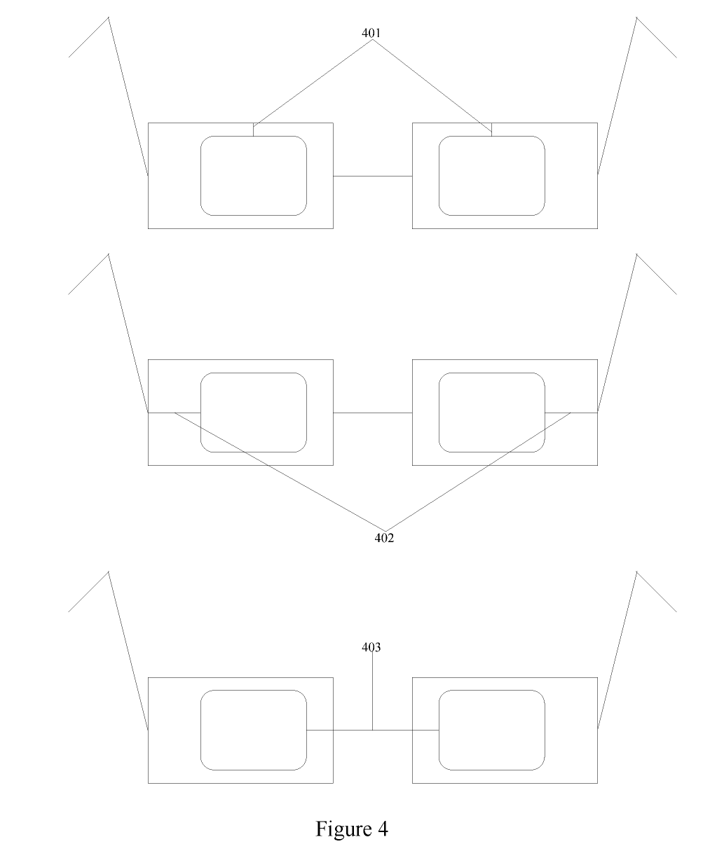

As shown in FIG. 2 and FIG. 3, the display devices 102 each include a minitype, light-weight, high-resolution display 201.

The display 201 is disposed at the outer side of the lens 101.

The minitype image of the display 201 enters an optical amplification module 203 to be amplified there into a virtual, large-size image 205 for entry into the human eye 204 after having been reflected once or twice by means of a reflection module 202. In accordance with the theory of convex lens imaging, 1/u+1/v=1/f, (f stands for focal distance, u stands for object distance, and v stands for image distance); when the object and the image are at the same side of the convex lens, they become amplified virtual images, by which time image distance v=fu/(u−f), whence it is possible to determine the distance and size of the virtual image by adjusting the object distance and selecting a lens with suitable focal distance.

The optical amplification module 203 is of a transparent material, so that the sight line is not occluded when the spectacles are normally used.

The reflection module 202 is a total reflection module.

The reflection module 202 and the optical amplification module 203 have an included angle of 45° therebetween.

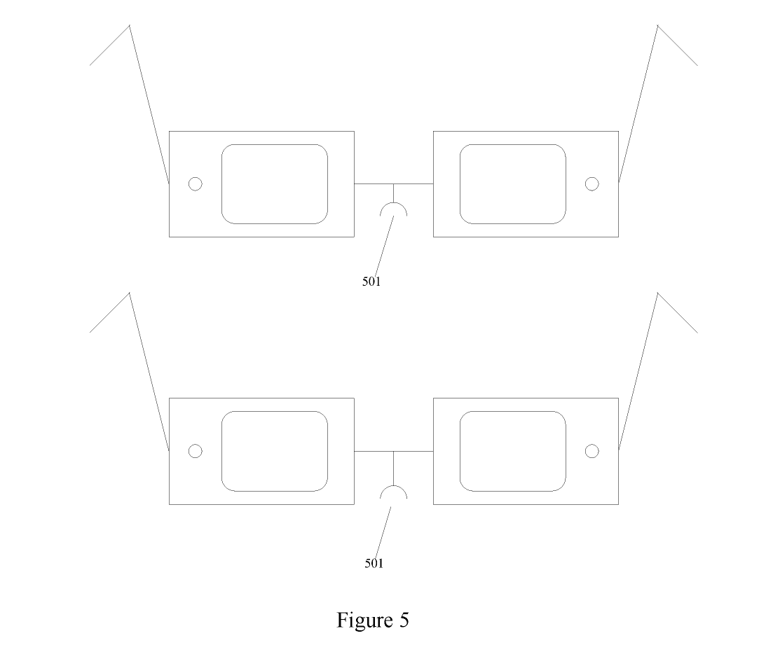

As shown in FIG. 4, positions of the display devices 102 are leftwards and rightwards adjustable through translatable connection points 401 or retractable connection points 402, 403, so that positions of the displays 201 can be independently adjusted according to the pupils of the left and right eyes of the user, so as to better match with the pupils of the two eyes of the user, thereby achieving the best 3D presentation effects. The translatable connection points 401 include a frame for securing the displays 201 and a connection device connected to the frame and leftwards and rightwards translatable on the spectacle frame 105; the retractable connection points 402, 403 each include a frame for securing the displays 201, and a freely retractable device connected to the left and right two sides of the frame.

The background light detection device 104 is disposed outside the lens 101 to detect background brightness in front of the eyes.

The display device 102 is automatically adjustable as to display brightness according to the background brightness, so that the screen brightness of the displays 201 is consistent with the background brightness, so as to prevent the eyes from being passively and repetitively adjusted, and to effectively reduce eye fatigue. At the same time, in the case of relatively low background brightness, the screen brightness is automatically lowered, thus effectively reducing display consumption while the visual requirement is satisfied.

Optionally, the lens 101 is a photochromatic lens whose color is automatically changeable in accordance with the background brightness; when the background brightness is high, the lens is automatically photosensitive to become dark color, whereby the screen brightness of the displays 201 is lowered under the precondition that it is ensured the user can clearly see the screen, thus effectively reducing power consumption and prolonging the use time of the system; whereas when the background brightness is low, the photochromatic lens is automatically photosensitive to become light color or colorless, so as to ensure that the user can clearly see the object in the background.

Optionally, when the lens is a photochromatic lens, the same photochromatic lens is also addable before the background light detection device 104, so that luminous intensity detected by the background light detection device 104 is consistent with luminous intensity behind the lens 101 formed by the photochromatic lens, thus ensuring precision in brightness adjustment; alternatively, relationship between background luminous intensity and light transmittance of the photochromatic lens is detected beforehand, and, in the case the photochromatic lens is used as the lens 101, the background luminous intensity is first obtained through the background light detection device 104, light transmittance of the photochromatic lens is tested under the background luminous intensity, and screen brightness of the display 201 is set via simulation calculation through software in accordance with the light transmittance of the photochromatic lens.

Optionally, the screen brightness of the display 201 is manually settable to adapt to visual requirements of different people in different environments.

Optionally, the lens 101 is one of a myopic mirror, a hyperopic mirror, and a clear mirror, and is freely substitutable among the myopic mirror, the hyperopic mirror, and the clear mirror, so as to satisfy visual requirements of different people.

Optionally, the device according to the present invention may further comprise a storage device 106 disposed on the spectacle frame 105 to store three-dimensional images from the collection device 103 or other external devices.

Optionally, the device according to the present invention further comprises a transmission device 107 disposed on the spectacle frame 105 to receive three-dimensional images from the collection device 103 or other external devices, or to transmit three-dimensional images to other external devices.

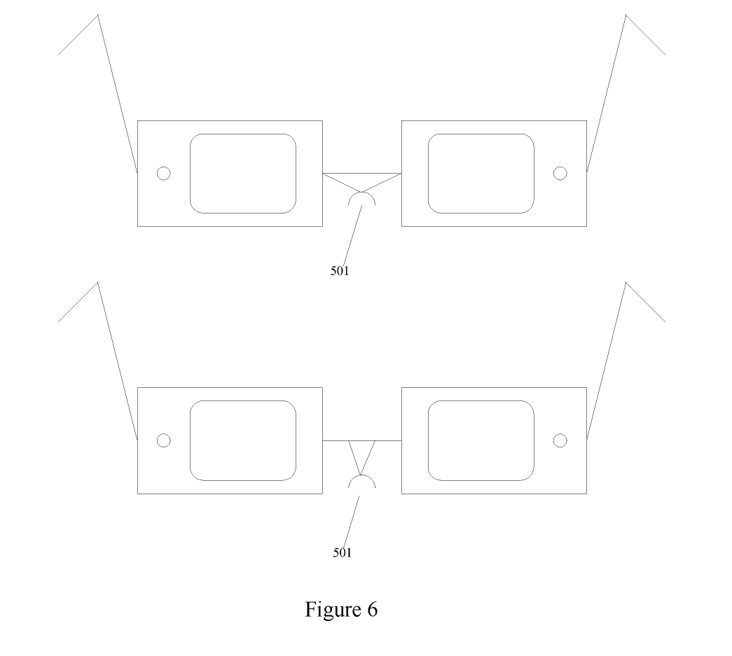

As shown in FIG. 5 and FIG. 6, the position of the nose pad 501 of the spectacle frame 105 is upwards and downwards adjustable according to control of the mode control device 108, so as to achieve switch between the moving mode and the direct vision mode.

When the mode control device 108 detects that the device is switched to the moving state by means of an acceleration sensor, a direction sensor, a magnetic sensor, a gravity sensor, a rotation vector sensor, a linear acceleration sensor, and the like, the position of the nose pad 501 is adjusted downwards, so that the display device 102 is raised upwards, and the moving mode is entered, whereby the user can browse information by raising the eyes, and the front sight is not occluded.

When the mode control device 108 detects that the device is switched to the stationary state by means of an acceleration sensor, a direction sensor, a magnetic sensor, a gravity sensor, a rotation vector sensor, a linear acceleration sensor, and the like, the position of the nose pad 501 is adjusted upwards, so that the display device 102 is located at a position in the due front of the eyes and parallel to the sight line, and the direct vision mode is entered, whereby the user can view video contents by direct vision, and it is not easy to feel tired.

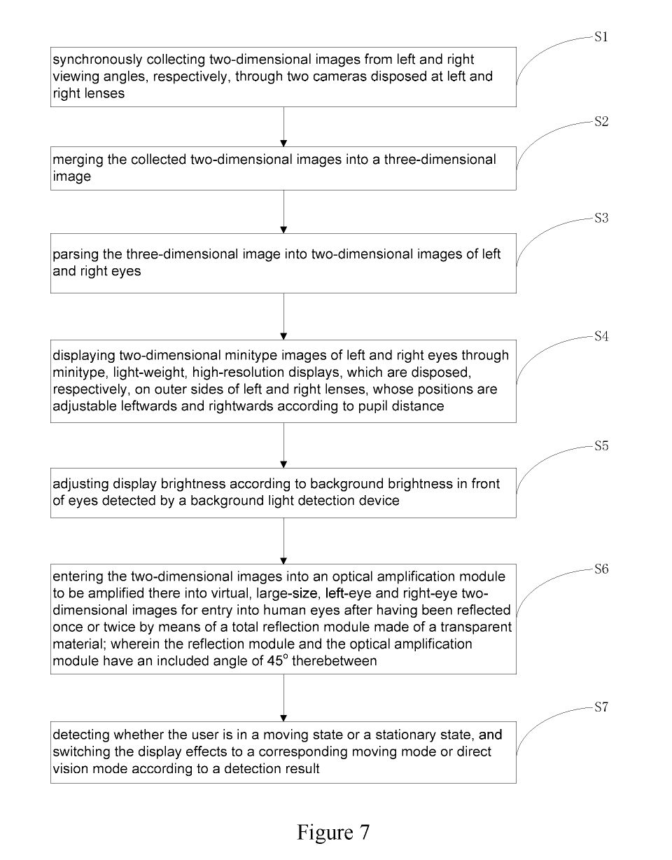

FIG. 7 is a processing flowchart illustrating a method based on collecting, transmitting and displaying a 3D image by means of the 3D intelligent device according to the present invention, which method comprises the following steps:

S1. synchronously collecting two-dimensional images from left and right viewing angles, respectively, through two cameras disposed at left and right lenses;

S2. merging the collected two-dimensional images into a three-dimensional image;

S3. parsing the three-dimensional image into two-dimensional images of left and right eyes;

S4. displaying two-dimensional minitype images of left and right eyes through minitype, light-weight, high-resolution displays, which are disposed, respectively, on outer sides of left and right lenses, whose positions are adjustable leftwards and rightwards according to pupil distance;

S5. adjusting display brightness according to background brightness in front of eyes detected by a background light detection device;

S6. entering the two-dimensional images into an optical amplification module to be amplified there into virtual, large-size, left-eye and right-eye two-dimensional images for entry into human eyes after having been reflected once or twice by means of a total reflection module made of a transparent material; wherein the reflection module and the optical amplification module have an included angle of 45° therebetween; and

S7. detecting whether the user is in a moving state or a stationary state, and switching the display effects to a corresponding moving mode or direct vision mode according to a detection result.

As should be understood, the aforementioned specific embodiments of the present invention are merely meant to exemplarily describe or explain the principles of the present invention, rather than constituting restrictions to the present invention. Therefore, all modifications, equivalent substitutions and improvements made without departing from the spirit and scope of the present invention shall fall within the protection scope of the present invention. In addition, the claims attached herewith are meant to cover all modifications and revisions that fall within the scope and boundary of the claims or within equivalent form of such scope and boundary.

1. A 3D intelligent device, comprising a spectacle frame and lenses, characterized in further comprising:
a collection device, for synchronously collecting two-dimensional images through two cameras disposed at the left and right lenses from left and right viewing angles, respectively, and merging the collected two-dimensional images into a three-dimensional image;
a background light detection device, for detecting background brightness in front of eyes;
a display device, for parsing the three-dimensional image into two-dimensional images of left and right eyes, presenting the same to a user, and for adjusting display brightness according to the background brightness, the display device comprising minitype, light-weight, high-resolution displays, which are disposed, respectively, on outer sides of the left and right lenses, whose positions are adjustable leftwards and rightwards according to pupil distance, wherein minitype, left-eye, and right-eye two-dimensional images of the displays enter an optical amplification module to be amplified there into virtual, large-size, left-eye and right-eye two-dimensional images for entry into human eyes after having been reflected once or twice by means of a total reflection module made of a transparent material, wherein the reflection module and the optical amplification module have an included angle of 45° therebetween; positions of the display device are leftwards and rightwards adjustable through translatable connection points or retractable connection points, so as to better match with the pupils of the two eyes of the user; and
a mode control device, for detecting whether the user is in a moving state or a stationary state, and switching the 3D intelligent device to a corresponding moving mode or direct vision mode according to a detection result; when the 3D intelligent device is switched to the moving state according to the detection result, the mode control device adjusts downwards the position of a nose pad disposed on the spectacle frame, so that the display device is raised upwards to enter the moving mode, when the 3D intelligent device is switched to the stationary state according to the detection result, the mode control device adjusts upwards the position of the nose pad disposed on the spectacle frame, so that the display device is located in the due front of eyes and parallel to sight line to enter the direct vision mode.

2. (canceled)

3. The device according to claim 1, characterized in that the background light detection device is disposed on the outer side of the lens, and that the display device is capable of automatically or manually adjusting display brightness in accordance with the background brightness; when the lens is a photochromatic lens whose color is automatically changeable in accordance with the background brightness, a same photochromatic lens is also added before the background light detection device, so that luminous intensity detected by the background light detection device is consistent with luminous intensity of the lens formed by the photochromatic lens; alternatively, relationship between background brightness and light transmittance of the photochromatic lens is detected beforehand, and, in the case the photochromatic lens is used as the lens, the background brightness is first obtained through the background light detection device, light transmittance of the photochromatic lens is tested under the background brightness, and screen brightness of the display is set via simulation calculation through software in accordance with the light transmittance of the photochromatic lens.

4. The device according to claim 3, characterized in that the lens is one of a myopic mirror, a hyperopic mirror, and a clear mirror, and that the lens is freely substitutable among the myopic mirror, the hyperopic mirror, and the clear mirror.

5. The device according to claim 3, characterized in further comprising: a transmission device, including at least one of a wired transmission module and a wireless transmission module, for receiving three-dimensional images from the collection device or other external devices, or transmitting three-dimensional images to other external devices; and
a storage device, for storing three-dimensional images from the collection device or other external devices.

6. A 3D image display method, characterized in comprising the steps of:
synchronously collecting two-dimensional images from left and right viewing angles, respectively, through two cameras disposed at left and right lenses;
merging the collected two-dimensional images into a three-dimensional image;
parsing the three-dimensional image into two-dimensional images of left and right eyes;
amplifying and displaying the two-dimensional images of left and right eyes through a display device; displaying two-dimensional minitype images of left and right eyes through minitype, light-weight, high-resolution displays, which are disposed, respectively, on outer sides of left and right lenses, whose positions are adjustable leftwards and rightwards according to pupil distance; entering the two-dimensional images into an optical amplification module to be amplified there into virtual, large-size, left-eye and right-eye two-dimensional images for entry into human eyes after having been reflected once or twice by means of a total reflection module made of a transparent material; wherein the reflection module and the optical amplification module have an included angle of 45° therebetween;
wherein the display device further adjusts display brightness according to background brightness in front of eyes detected by a background light detection device at the same time of displaying the left-eye and right-eye two-dimensional images;
detecting whether a user is in a moving state or a stationary state, and switching display effect to a corresponding moving mode or direct vision mode according to a detection result; when the 3D intelligent device is switched to the moving state according to the detection result, the mode control device adjusts downwards the position of a nose pad disposed on the spectacle frame, so that the display device is raised upwards to enter the moving mode; when the 3D intelligent device is switched to the stationary state according to the detection result, the mode control device adjusts upwards the position of the nose pad disposed on the spectacle frame, so that the display device is located in the due front of eyes and parallel to sight line to enter the direct vision mode.

7. (canceled)

8. The method according to claim 6, characterized in that the background light detection device is disposed on the outer side of the lens, and that the display device is capable of automatically or manually adjusting display brightness in accordance with the background brightness; when the lens is a photochromatic lens whose color is automatically changeable in accordance with the background brightness, a same photochromatic lens is also added before the background light detection device, so that luminous intensity detected by the background light detection device is consistent with luminous intensity of the lens formed by the photochromatic lens; alternatively, relationship between background brightness and light transmittance of the photochromatic lens is detected beforehand, and, in the case the photochromatic lens is used as the lens, the background brightness is first obtained through the background light detection device, light transmittance of the photochromatic lens is tested under the background brightness, and screen brightness of the display is set via simulation calculation through software in accordance with the light transmittance of the photochromatic lens.

9. The method according to claim 8, characterized in that the 3D intelligent device comprises a spectacle frame;
that the lens is one of a myopic mirror, a hyperopic mirror, and a clear mirror, and that the lens is freely substitutable among the myopic mirror, the hyperopic mirror, and the clear mirror.

10. The method according to claim 8, characterized in further comprising:
receiving, through a transmission device that includes at least one of a wired transmission module and a wireless transmission module, three-dimensional images from other external devices or a collection device that includes the two cameras; and
storing, through a storage device ,the three-dimensional images from the other external devices or the collection device.
